(19) United States
(12) Patent Application Publication
(10) Pub. No.: US 2004/0135885 A1
(43) Pub. Date: Jul. 15, 2004

(54) Non-intrusive sensor and method

(76) Inventor: George Hage, Poway, CA (US)

Correspondence Address: GAZDZINSKI & ASSOCIATES, Suite 375, 11440 West Bernardo Court, San Diego, CA, 92127, US

(21) Appl. No.: 10/686,877

(22) Filed: Oct. 16, 2003

Related U.S. Application Data
(60) Provisional application No. 60/419,241, filed on Oct. 16, 2002.

(51) Int. Cl. H04N 7/18

(52) U.S. Cl. 348/143; 340/522

(57) ABSTRACT

A sensor assembly adapted for remotely monitoring spaces such as residences or businesses, with enhanced privacy. In one exemplary embodiment, the sensor assembly is configured to look like a convention passive infrared device (PIR), and includes a CMOS camera and associated data processing. The data processing selectively alters the image data obtained by the camera so as to allow a remote operator to view only certain features of the data, thereby maintaining privacy while still allowing for visual monitoring (such as during alarm conditions to verify “false alarm” status). Alternate system configurations with local and/or remote data processing and hardwired or wireless interfaces are also disclosed.

### PRIORITY

This application claims priority benefit of U.S. provisional patent application Serial No. 60/419,241 entitled “NON-INTRUSIVE SECURITY SENSOR AND METHOD” filed Oct. 16, 2002, which is incorporated by reference herein in its entirety.

### 1. FIELD OF THE INVENTION

The present invention relates generally to sensor and monitoring systems, and specifically to improved apparatus for non-intrusively monitoring one or more remote locations, and methods for utilizing the same.

### 2. DESCRIPTION OF RELATED TECHNOLOGY

A variety of different types and configurations of security monitoring and sensor systems are known in the prior art. Generally, these systems comprise hard-wired (or wireless) optical or video security cameras such as those used for permanent surveillance in banks, at ATM machines, or unguarded locations. These systems may also be adapted for in-home (residential) use.

While being at least arguably effective in dissuading would-be criminals from illegal acts based on their overt presence, these prior art systems suffer from many drawbacks, especially in the context of residential use. Specifically, one significant drawback relates to the degree of invasiveness of the monitoring. Many people, while desiring enhanced security, do not wish to be monitored visually at all times while at home, especially by a third party. This is especially true when engaged in sensitive or compromising activities such as showering, dressing, etc. Existing security cameras are generally either “on” or “off”, and hence many people tend to simply turn these cameras off (or not have them installed in the first place) rather than suffer invasion of privacy. Hence, their security is in effect traded for privacy.

Another disability with prior art systems relates to their overt presence; while good for certain applications to deter certain activities, they are not suited to applications where covert monitoring is required. One exemplary instance of such an application comprises the so-called “nanny-cam”, wherein parents secretly monitor the activities of their nanny via a hidden video system. Numerous hidden camera systems exist, generally secreted in one device or another so as to hide their existence. However, these installations are generally table-top or similar items (e.g., clocks or books, etc.) whose placement is at the whim of prevailing furniture layout. Furthermore, a narrow field of view is often provided by such devices. Wall mounting is often prohibitively difficult as well, since separate wiring penetrations or interfaces are required to support the camera.

Note that the foregoing prior art systems are also directed to maintaining the presence of the camera completely secret, to be contrasted with keeping it in plain view yet disguising it as another (non-threatening) security device.

Yet another disability with prior art systems relates to their cost; generally, security systems (including remote cameras) are fairly costly items which are not amenable to frequent replacement. For example, where the environment in which the camera is used is inhospitable (such as due to the environment, vandalism, etc.), they must be somehow protected from the deleterious effects of these influences, lest the operator incur significant costs associated with frequent camera replacement. Notably, however, recent technological advances have made camera devices such as CCD and CMOS devices much more economical.

Prior art camera and sensor solutions are also typically not equipped with signal processing capabilities whereby the data generated by the sensor is processed to provide some desired signal conditioning or analysis. This is especially true of “lower end” models such as the type commonly used in residential applications.

Despite the broad variety of prior art security monitoring solutions, there exists a need for a low-cost and easily manipulated solution to interchanging the sensor(s), such as for replacement (maintenance). Specifically, it would be ideal if a configuration were provided which allows simple actuation of a mechanism to completely dissociate the low-cost or disposable sensor with its support assembly (i.e., “quick disconnect”), and subsequent insertion of a new sensor in its place with similar ease. This solution would ideally also allow as an option the “hot” or energized change-out of the sensor, thereby obviating having to power the assembly down before conducting the replacement operation.

Furthermore, there is a need for a highly covert security sensor which, while ideally in plain view, does not alert those being monitored to its true purpose. Such improved solution could ideally be co-located with existing security apparatus (e.g., a PIR alarm system), thereby requiring a minimum of new wiring or installation, and providing a broad-field view of critical areas of the premises being monitored.

Additionally, there is a need for an improved monitoring apparatus and method by which constant or near-constant monitoring of one or more areas within a premises may be conducted without compromising either the inhabitant's privacy or security.

### SUMMARY OF THE INVENTION

The present invention satisfies the aforementioned needs by providing an improved sensor apparatus and associated methods.

In a first aspect of the invention, an improved non-intrusive sensor assembly is disclosed, generally comprising a sensor element and associated processing functionality adapted to selectively alter the data obtained by the sensor. In one exemplary embodiment, the sensor comprises one or more complementary metal oxide semiconductor (CMOS) camera which is integrated into a housing, the housing disposed at a desired monitoring location. Data obtained by the CMOS camera is selectively altered using a signal processing element in order to achieve a desired effect on the data; i.e., reduced focus of “fuzzing” of the image when displayed on a remote security monitor. The signal processing element comprises, inter alia, software adapted to manipulate the raw sensor data to produce the desired effect. The software resides as embedded code on digital signal processor (DSP) located within the sensor assembly. In another exemplary embodiment, the signal processing is accomplished external to the sensor (but locally), thereby allowing for modularity and replacement of failed sensors independent of the signal processing element. In yet another embodiment, the signal processing is accomplished remotely (i.e., remote from the monitored location(s)) after the raw data from the sensor is streamed over a data link.

In a second aspect of the invention, a low-cost, replaceable sensor apparatus is disclosed, generally comprising: a low cost camera element; a low-cost molded housing element substantially containing the camera element; and a molded base element removably coupled to the housing element; wherein the camera element and housing element cooperate to make said sensor apparatus substantially disposable from a cost perspective. In one embodiment, an ultra-low cost B/W semiconductor camera element is used along with one or more electronic components disposed off of the replaceable camera apparatus, thereby reducing the cost of replacement camera modules to an absolute minimum.

In a third aspect of the invention, a method of operating the aforementioned sensor assembly is disclosed. The method generally comprises providing a sensor adapted to process raw sensor data to produce a desired result; obtaining raw data via the sensor; processing the data to produce a processed sensor output; and utilizing the sensor output for monitoring. In one exemplary embodiment, the sensor comprises the aforementioned CMOS camera, and act of processing the raw sensor data comprises processing the data via a software entity to reduce the visual clarity or resolution of the image upon subsequent display. The software entity is disposed generally local to the sensor, thereby allowing only the processed data to be transmitted to the remote monitoring facility, thereby enhancing the privacy of the resident of the location being monitored.

In a fourth aspect of the invention, an improved remote monitoring system is disclosed. The system generally comprises one or more sensors disposed at one or more locations to be monitored; at least one processing entity adapted to process raw data from the sensors, and at least one remote monitoring entity adapted to utilize the processed data. In one exemplary embodiment, the system comprises an array of CMOS cameras disposed at various locations throughout a monitored facility (e.g., residence), and the processing entity comprises an embedded signal processing board also locally disposed at the monitored facility. Data generated by the sensors is processed by the signal processing board, and the processed data output from the signal processing board transmitted to one or more remote monitoring locations via conventional data link; e.g., twisted pair electrical conductors or Category 5 cabling, or wireless interface.

In a fifth aspect of the invention, a method of manufacturing a low-cost sensor assembly is disclosed, the method generally comprising: providing a low cost sensor; molding a housing member adapted to accommodate at least a portion of the sensor; disposing the sensor at least partly within the housing member; providing a quick-disconnect base element adapted for mating with the housing member, the base element facilitating rapid disconnection and replacement of the housing member; and mating said housing member with the base element.

In a sixth aspect of the invention, a method of operating security monitoring apparatus disposed at a first location is disclosed, the method generally comprising: providing at least one sensor having signal processing apparatus; processing the first data collected by the at least one sensor using the apparatus to produce second data, the second data having at least one attribute associated therewith; monitoring the first location using the second data; and selectively, and responsive to a first indication, monitoring the first location using said first data. In one exemplary embodiment, the second location comprises a remote security monitoring location adapted to monitor a plurality of different first locations. Upon receipt of a burglar alarm, “panic” signal, or other indicia from a monitored location, the system switches from a high-privacy mode to a complete (i.e., high resolution) viewing mode to enable the remote station to better determine the nature of the alarm and need for follow-up action.

### BRIEF DESCRIPTION OF THE DRAWINGS

The features, objectives, and advantages of the invention will become more apparent from the detailed description set forth below when taken in conjunction with the drawings, wherein:

FIG. 1 is a front perspective view of a first exemplary embodiment of the sensor assembly according to the present invention, shown fully assembled and installed.

FIG. 2 is an exploded perspective view of the sensor assembly of FIG. 1, shown partially disassembled and unmounted.

FIGS. 2a and 2b illustrate typical video data images obtained both before and after signal processing according to the invention, respectively.

FIG. 2c and 2d illustrate an alternate embodiment of the signal processing performed by the invention, wherein one or multiple selected regions are blanked, respectively.

FIG. 2e illustrates yet another alternate embodiment of the signal processing of the invention, wherein the image data is made mosaic.

FIGS. 3a(i)-3a(vi) illustrate various views of a first alternate configuration of the sensor assembly of the present invention.

FIGS. 3b(i)-3b(vi) illustrate various views of a second alternate configuration of the sensor assembly of the present invention.

FIGS. 3c(i)-3c(vi) illustrate various views of a third alternate configuration of the sensor assembly of the present invention.

FIGS. 3d(i)-3d(vi) illustrate various views of a fourth alternate configuration of the sensor assembly of the present invention.

FIGS. 3e(i)-3e(vi) illustrate various views of a fifth alternate configuration of the sensor assembly of the present invention.

FIG. 4a is a functional block diagram of one exemplary configuration of the monitoring system of the invention, utilizing local signal processing within one or more of the sensor assemblies.

FIG. 4b is a functional block diagram of one exemplary configuration of the monitoring system of the invention, utilizing local signal processing within a centralized processing board.

FIG. 4c is a functional block diagram of one exemplary configuration of the monitoring system of the invention, utilizing remote signal processing.

FIG. 5 is a logical flow diagram illustrating one exemplary method for manufacturing the sensor apparatus of the present invention.

### DETAILED DESCRIPTION OF THE PREFERRED EMBODIMENT

Reference is now made to the drawings wherein like numerals refer to like parts throughout.

It is noted that while the following description is cast primarily in terms of a camera sensor utilizing one or more complementary metal oxide semiconductor (CMOS) devices of the type well known in the electronic arts, cameras or optical viewing devices utilizing other operating principles and technologies (such as charge-coupled devices, or CCDs) may be substituted. Additionally, it will be recognized that other types of sensors may be substituted in place of the camera described herein, including without limitation infrared (IR) sensors. Hence, the term “sensor” as used herein shall be broadly construed to include all such devices.

It is further noted that while the following description is cast primarily in terms of a security monitoring system, such as might be used in providing security for a home or small office, the apparatus and methods disclosed herein are equally adapted to other types of environments where signal processing of sensor data is desirable.

Additionally, it will be recognized that the term “camera” as used herein may also include supporting or ancillary components associated with the operation thereof, such as for example a sample-and-hold circuit used to drive a CCD array, data storage device (e.g., RAM/ROM), motorized focal variation drive, or local power supply.

As used herein, “RAM” shall be meant to include, without limitation, SRAM, SDRAM, DRAM, SDRAM, EDR-DRAM, whether embedded or otherwise. ROM shall be meant to include, without limitation, PROM, EPROM, EEPROM, UV-EPROM, FLASH, embedded or otherwise.

As used herein, the terms “electrical component” and “electronic component” are used interchangeably and refer to components adapted to provide some electrical function, including without limitation inductive reactors (“choke coils”), transformers, filters, toroid cores, inductors, capacitors, resistors, operational amplifiers, and diodes, whether discrete components or integrated circuits, whether alone or in combination. As used herein, the term “integrated circuit” includes any sort of integrated device including, without limitation, application specific ICs (ASICs), FPGAs, digital processors, SoC devices, etc.

As used herein, the terms “digital processor” or “processor” shall be understood to include microprocessors (CISC or otherwise), RISC processors, digital signal processors (DSPs), microcontrollers, or any other device adapted for digital data processing. Exemplary DSPs include the Motorola MSC8102, Lucent Technologies DSP16000 family, Texas Instruments TMS320C6x family, and Hitachi SuperH family. Exemplary RISC processors include those produced by ARM, Ltd. and the ARC International Tangent A4/A5 processor.

Sensor Apparatus

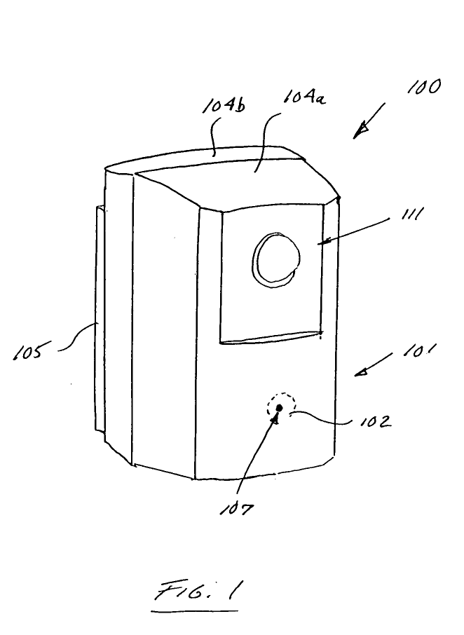

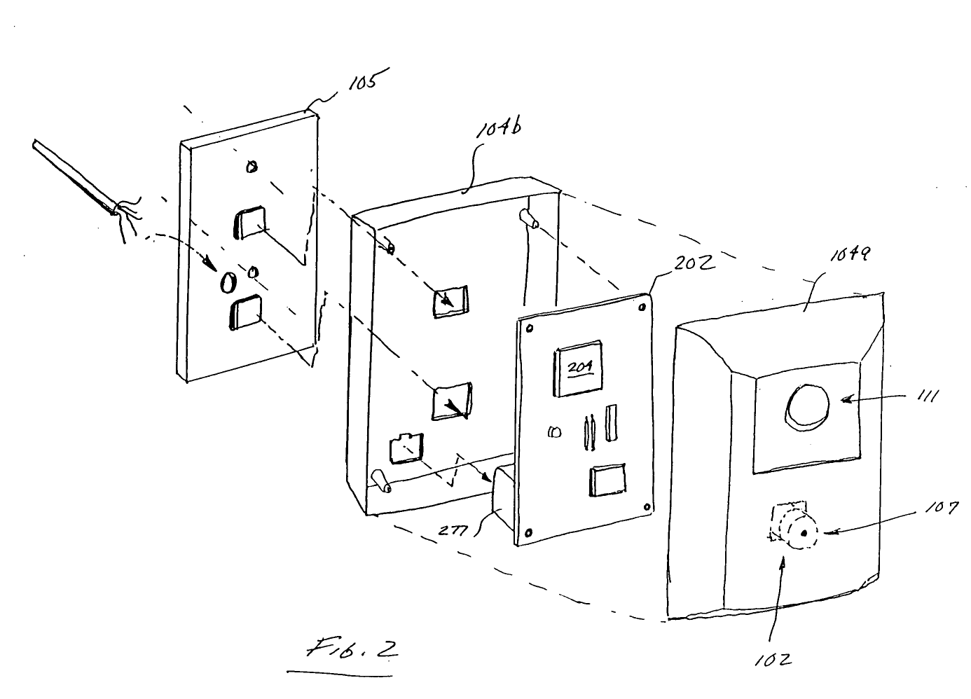

Referring now to FIGS. 1-3, a first exemplary embodiment of the sensor apparatus is described in detail. As shown in FIG. 1, the sensor assembly 100 generally comprises a camera assembly 101 with integral camera 102, a housing element 104a, 104b surround the camera assembly 101, and a base element 105 coupled to the housing element 104. The housing 104 is coupled to the base element 105 as shown in FIG. 1 such that the former is supported in the proper position(s) by, and removed from if desired, the latter by the user. In the illustrated embodiment, a low-cost black-and-white (B/W) CMOS-based camera element of the type well known in the art is used, thereby simplifying the construction and reducing the cost of the sensor assembly 100 as a whole. This also advantageously reduces the cost of replacement of the camera element 102 (or the sensor 100 as a whole) upon device failure, thereby tending to make the unit more “disposable” in nature. It will be appreciated, however, that other types of cameras or sensors may be substituted as previously discussed. Furthermore, the sensor assembly 100 may be combined with and/or incorporate the features of other types of sensor assemblies including, for example, those detailed in commonly owned U.S. Patent Application Ser. No. 10/382,747 filed Mar. 5, 2003 (which claims priority to provisional application Nos. 60/362,117 entitled “Quick-release Sensor Assembly and Method” filed Mar. 5, 2002), and 60/376,156 entitled “Reversing Sensor Assembly and Method” filed Apr. 25, 2002, each incorporated herein by reference in their entirety.

The assembly 100 also includes one or more infrared (IR) sensors 111, which in the illustrated embodiment, are passive in nature.

Both the housing 104 and the base 105 in the illustrated embodiment are formed from a polymer such as polyethylene, polystyrene, or other plastic having suitable mechanical properties, although it will be recognized that other materials (polymer or otherwise) may be substituted. Polymers (e.g., plastics) are chosen for their low cost and ease of manufacturing. A window or aperture 107 is also provided in the housing 104 to permit light to pass from the exterior of the housing to the active surface of the CMOS camera 102. The aperture 107 may comprise a “pinhole” aperture for discrete viewing, a transparent (or translucent, as described below) material, or alternatively have no material interposed between the CMOS active surface and the light source. As yet another alternative, a selectively opened aperture (not shown) may be utilized, wherein the opening/closing of the aperture is controlled by a control input, such as the signal from an ultrasonic or IR sensor which detects the presence/motion of a person in the space being monitored and accordingly triggers video monitoring via the CMOS camera 102. Other alternatives for the aperture (including, for example, the use of photosensitive materials which alter the opacity of the material as a function of incident light energy intensity/wavelength) may be used as well. In the exemplary embodiment of FIG. 1, a pinhole aperture 107 is utilized, thereby providing environmental protection for the camera 102, and making the external appearance of the housing 104 more uniform and less obtrusive. This also helps mitigate concerns by monitored personnel (e.g., homeowners or their guests) that they are being “watched” since the exemplary housing is configured to appear similar or identical to a conventional passive infrared (PIR) security device. Hence, people not having knowledge of the presence of the camera (sensor) within the housing will not be able to detect that they are being monitored on video. This is advantageous from several perspectives, including allowing for candid monitoring of persons who may believe that the sensor assembly 100 they view is merely an IR-based system, and therefore will not adjust their behavior accordingly. This goal can also be achieved through use of a substantially transparent polymer window material which appears opaque when viewed from the exterior (i.e., polarized or “two-way” material) in place of the aforementioned pinhole aperture.

The housing 104 in the present embodiment is further adapted to be removed from the base 105, such as by a snap or friction fit, or alternatively through one or more threaded fasteners accessible on the exterior surfaces of the housing/base. The base 105 is adapted to mate with a mounting surface (e.g., interior wall of a room), and may be fastened thereto using any number of well known techniques including adhesive pads, screws/anchors, or even a separate mounting base (not shown) with fixed posts which allows easy installation/removal of the assembly.

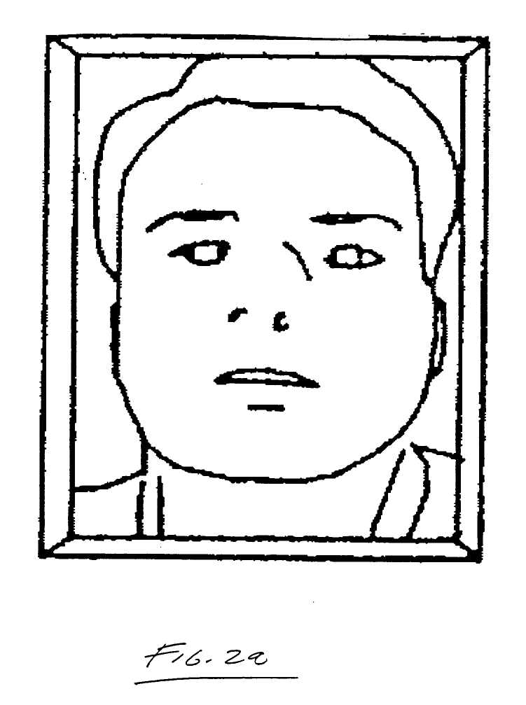

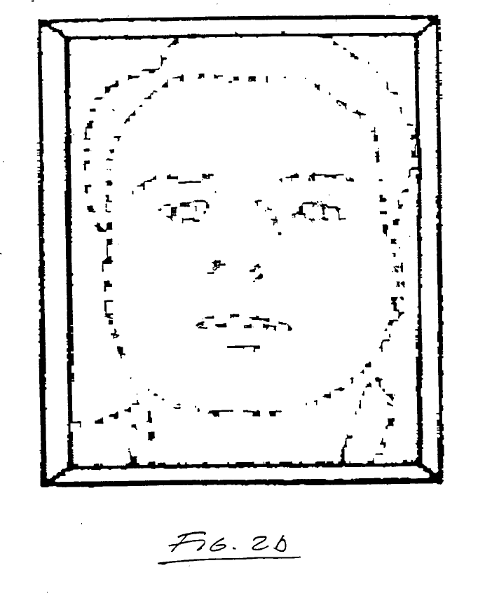

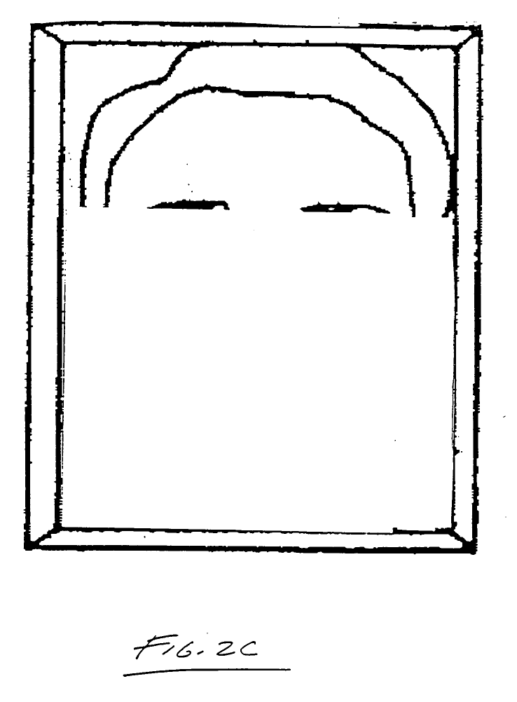

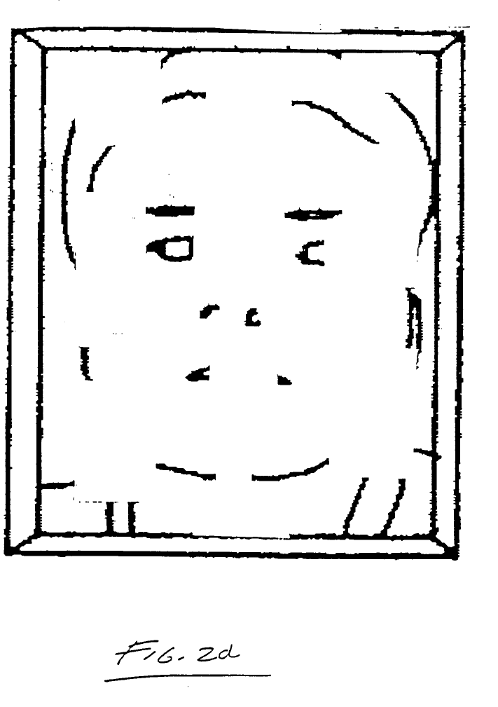

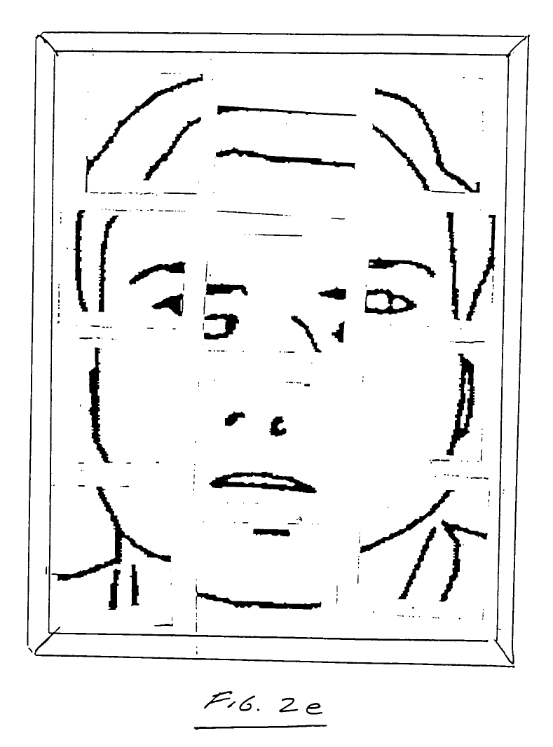

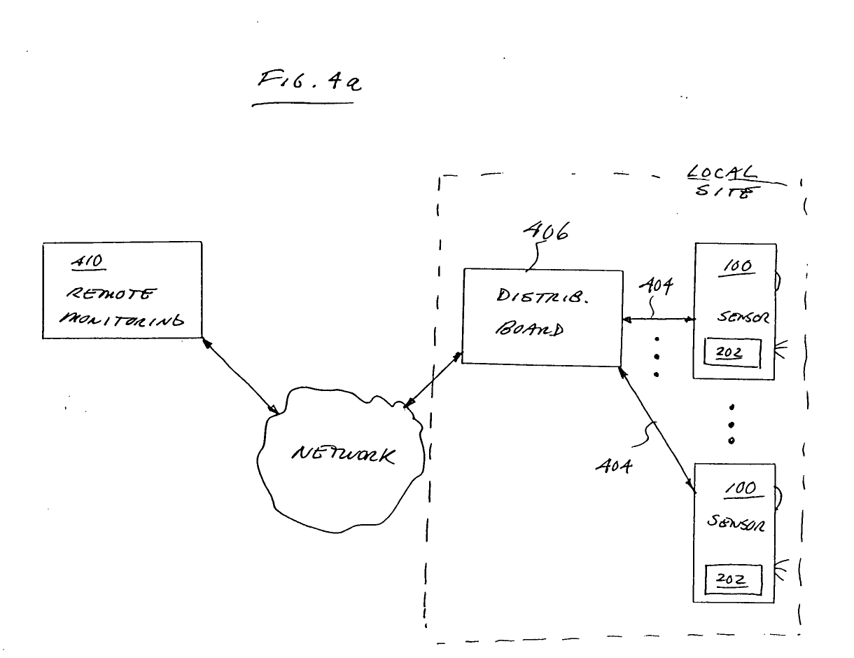

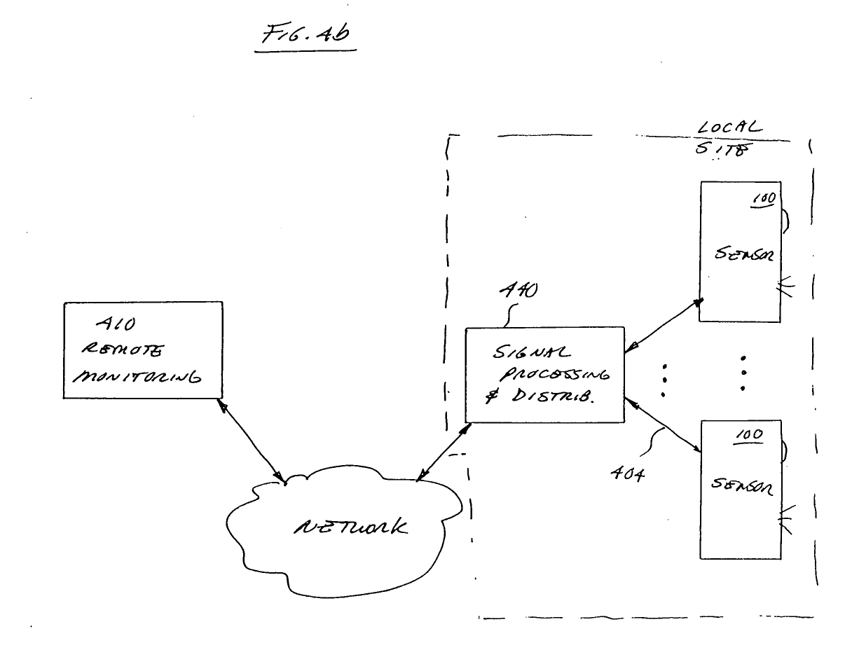

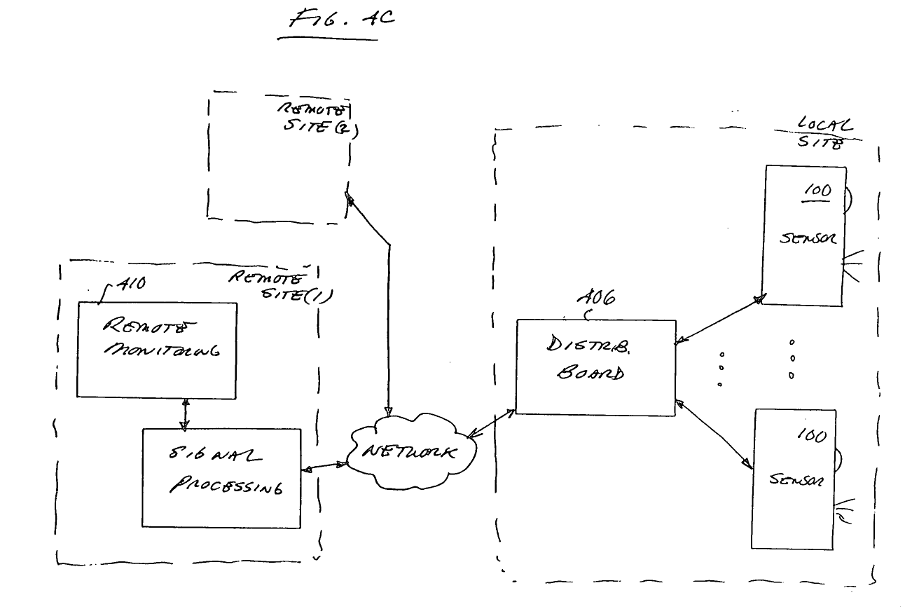

The illustrated embodiment of the sensor assembly 100 further includes a signal processing board 202 (see FIG. 2) which, inter alia, processes the signals produced by the camera assembly 101. Specifically, the processing of these signals in the present embodiment comprises reducing the visual clarity or resolution of the images through processing of the “raw” (i.e., unprocessed) data generated by the camera 102. Such processing may include for example selective deletion or elimination of certain raw video data according to a deterministic (or non-deterministic) scheme, permutation of data or sets of data within the image, etc. Software routines which are adapted to provide such video data processing are well known and readily constructed by those of ordinary skill in the art, and accordingly not described further herein. The software is in the illustrated embodiment adapted to run from the embedded (program) memory of a digital processor 204 on the signal processing board 202, with which the output of the camera element 101 is in data communication. Data output by the CMOS camera 102 is advantageously converted to the digital domain, thereby facilitating processing and subsequent transmission to a remote monitoring entity (although the reverse order may be used, such as in the embodiment of FIG. 4b described below). Appropriate signal buffering is provided within the sensor assembly 100 via, e.g., a conventional RAM or FIFO storage device, thereby allowing for non-real time processing and/or distribution of the data.

In the exemplary embodiment, the signal processing board 202 is a printed circuit board (PCB) mounted in a generally planar configuration parallel to the rear surface 108 of the assembly 100. The PCB contains, inter alia, a plurality of conductive traces, and electrical/electronic components (including the aforementioned integrated circuits). An option RJ-style modular jack connector 277 (e.g., RJ-11, RJ-45, etc.) is disposed on the rear face of the board 202 to facilitate data connection to the sensor assembly 101. The board 202 may also be configured to receive external power (e.g., 115 VAC, 60 Hz or other power). In another exemplary embodiment, the assembly 100 is outfitted with its own internal power supply, such as one or more batteries as is well known in the art. Such internal power supply may act as the primary source of power, or alternatively a backup during failure of the primary (external) power source.

External AC power received at the assembly is also converted to the proper voltage (via a transformer or comparable device), and rectified if required. Alternatively, external DC power can be supplied to the assembly, thereby obviating such voltage transformation and rectification if desired.

FIGS. 2a-2b illustrates an exemplary optical image obtained from the CMOS camera 102 of the sensor assembly 100, both before and after processing according to the invention respectively. As shown in the first image 270 (FIG. 2a), full visual resolution and clarity are provided (within the limits of the extant camera system 102). After processing (FIG. 2b), the image 272 has substantially degraded resolution and clarity, thereby allowing the remote monitoring entity (e.g., security service, police, etc.) to see generally only shapes with no real features. This reduction in clarity and resolution, inter alia, overcomes the significant barriers to widespread residential use associated with prior art video monitoring systems; i.e., the desire of individuals not to be “watched” in their homes, especially during times when they would prefer not to be observed in any detail (such as when their appearance is not good, they are dressing/undressing, etc.). The level of resolution reduction or degradation can be controlled to any desired level, including variable or dynamic control based on externalities such as ambient lighting (e.g., provided by a photoelectric sensor), the range at which primary targets of interest are/will be viewed (e.g., preprogrammed or alternatively observed via ultrasonic rangefinder), the time of day, sensed acoustic levels, etc.

The aforementioned reduction in resolution and clarity also addresses another significant problem associated with existing security monitoring systems; i.e., spurious or false alarms. As is well known, spurious and false security system alarms expend large amounts of resources needlessly, and can divert attention of the limited security and enforcement assets available from locations where their presence is actually required. Many municipalities are also charging residents/businesses for false alarms to which they must respond. This situation creates two related problems: (i) a disincentive for residents/business owners to install or activate security systems for fear of incurring costs or burden due to false alarms; and (ii) disincentive for security or police to respond (with any particular urgency) since the great majority of alarms received ultimately turn out to be false. The present invention substantially addresses all of these issues, by allowing the remote monitoring entity to reliably verify if in fact the alarm is false through visual verification. Specifically, the processed images transmitted by the sensor assemblies can be used to determine if the residence or business is occupied, and generally what type of activity is occurring there. The privacy of the occupants is maintained at all times, since the resolution of the transmitted images is not sufficient to determine any privacy-related details.

Note that the sensors 100 and associated components described below may also be configured to transmit the processed video data only upon the triggering of an alarm (e.g., when a window or door goes ajar, or a motion detector detects motion in the monitored space). That way, the remote monitoring facility need not utilize assets for monitoring locations which have a low (albeit non-zero) probability of actually having an intrusion occurring without a corresponding alarm being triggered. Furthermore, this provides added privacy to the occupants who may not want even reduced-resolution monitoring during certain time periods. Similarly, the sensor assemblies 100 may optionally be configured with a time-delay feature, wherein upon triggering via one of the aforementioned events, reduced clarity visual monitoring is enabled after a prescribed period of time (e.g., 15 second), thereby allowing the occupants to cease any potentially compromising activities before the remote monitoring entity can view them.

The reduced resolution/clarity of the present embodiment can also be adjusted (within prescribed limits) such that the person being monitored and/or remote monitoring facility can alter how much detail is passed to the remote monitoring facility. This feature allows sensors in different locations to be “tuned” to the prevailing conditions or level of clarity desired. Hence, while a sensor installed in the kitchen of a house may be tuned for higher resolution, a comparable sensor in the bedroom or bathroom may be tuned for lower resolution, since the latter are more private in nature. Similarly, the sensor assemblies (collectively or individually) may be tuned to vary the level of processing as a function of prevailing ambient light, such as via a conventional photo-electric sensor (not shown). For example, when the photo-electric sensor detects light of sufficient intensity in the desired wavelength band, it passes a signal to the signal processing board of the sensor assembly, the latter adjusting its processing to reduce visual clarity and resolution of the processed image, since more ambient light is available.

In another embodiment, the processing of the video signal performed by the signal processing board (or central board, described below) can be selectively eliminated based on, e.g., a gating or permissive criterion, thereby allowing unprocessed data to be distributed to the monitoring entity. For example, in one configuration, unprocessed video data may be selectively transmitted when a corresponding ultrasonic or IR detector detects no persons or motion within the field of view of the camera 102 (as indicated for example by no Doppler shift or IR signature, respectively). Alternatively, when a signal corresponding to activation of a “panic” function is generated, complete (unprocessed) signal is transmitted to the remote monitoring facility. Such a panic function might include for example a secret button (not shown) known to the occupant of the location being monitored, the button being depressed when the occupant suspects an intrusion, is in fear of their life, or other calamity such as fire occurs. By removing the signal processing, a clear picture of the field(s) of view of one or more sensors is immediately provided, thereby potentially aiding the monitoring entity in sending appropriate assistance (police, fire, etc.), identifying criminal perpetrators, and evaluating and determining false alarms.

As discussed above, the sensor assembly may also be configured to switch operating modes between off (no sensor data), reduced resolution monitoring (processed data), and high resolution monitoring (unprocessed data) at different times or under different circumstances. Consider the example of the small business security system configured such that (i) no data is generated in the absence of any alarm conditions, (ii) processed data is streamed when an alarm condition is present, yet with no corresponding motion detection; and (iii) full resolution (unprocessed) data is streamed when both an alarm condition exists and motion within the monitored space is detected. Clearly, numerous permutations of the foregoing features and corresponding control schemes may be employed consistent with the present invention, those explicity described being merely illustrative.

In another embodiment (FIG. 2c), the processing of the raw video data comprises selective blanking of certain regions of the field of view (alone or in combination with the aforementioned reduced resolution processing). For example, a sensor assembly installed within a residential bathroom might have all field of view below a certain level (e.g., head level) completely blanked, thereby allowing monitoring of only the upper-most volume of the room, where no privacy or modesty issues would exist. Similarly, “patchwork” blanking can be utilized, wherein a pattern of blanked regions is created in the image data (FIG. 2d).

In yet another embodiment (FIG. 2e), the image data may be made “mosaic” or otherwise distorted, such as by creating spatial discontinuities within the image (e.g., by shifting certain block of data in row and/or column address, such as by using a data shift register, or by applying other mathematical functions to the digitized image data), thereby making the resulting image have reduced clarity and resolution. Numerous techniques for mosaic and distortion effects of video images exist; see, e.g., U.S. Pat. No. 5,802,210 entitled “Image Processing System” issued Sep. 1, 1998 to Kurata, et al, which is incorporated by reference herein in its entirety.

Yet other methods of reducing the clarity and resolution of a video image not specifically described herein but known to those of ordinary skill may be employed consistent with the invention; the foregoing techniques should not therefore be considered limiting in any way. For example, another embodiment of the present invention contemplates use of a window or aperture covering (not shown) which has relatively high opacity or optical distortion, thereby effectively “fuzzing” any images sensed by the camera 102.

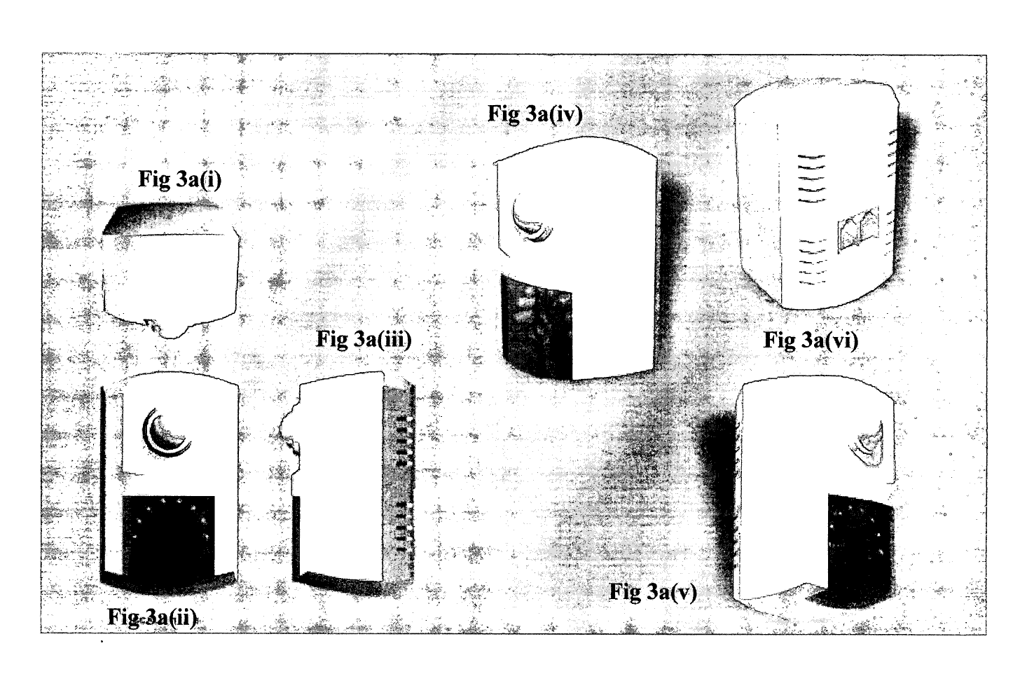

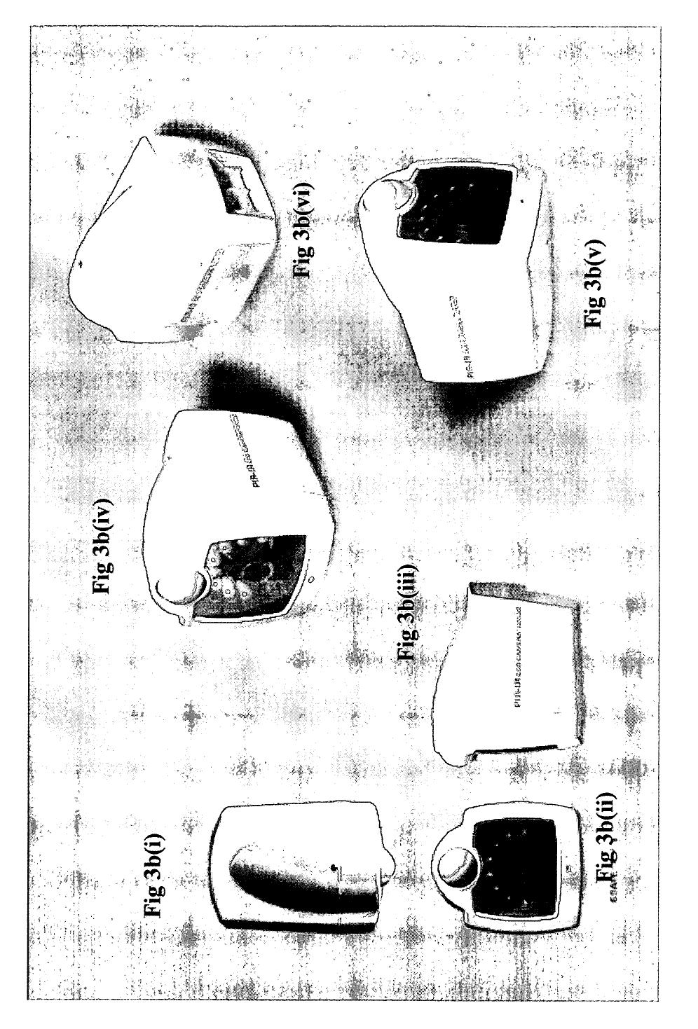

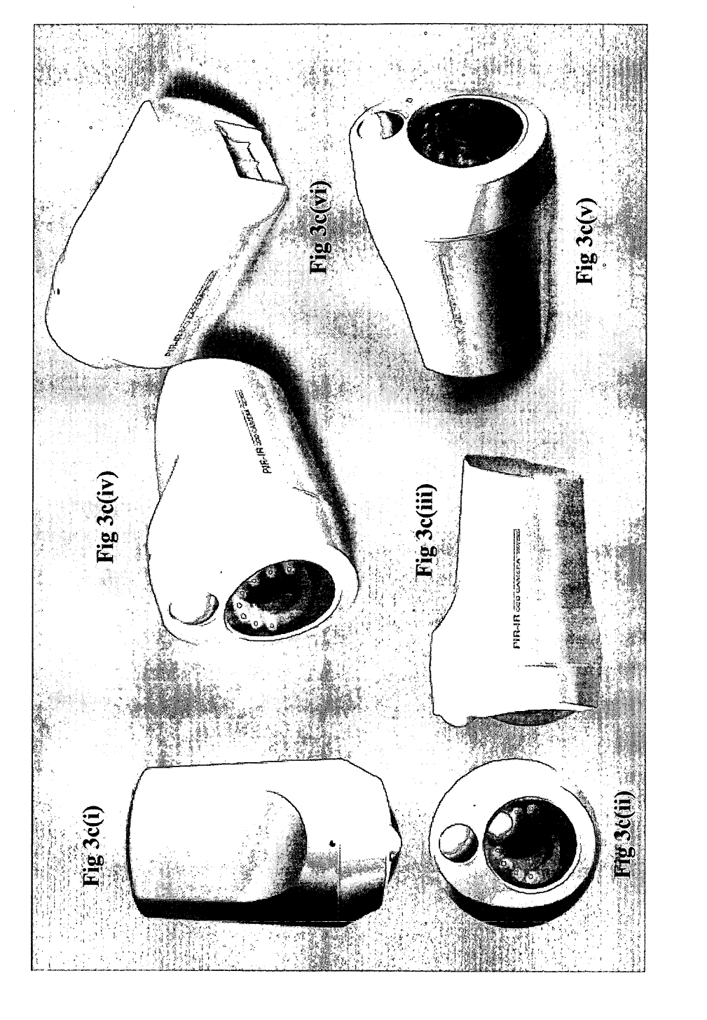

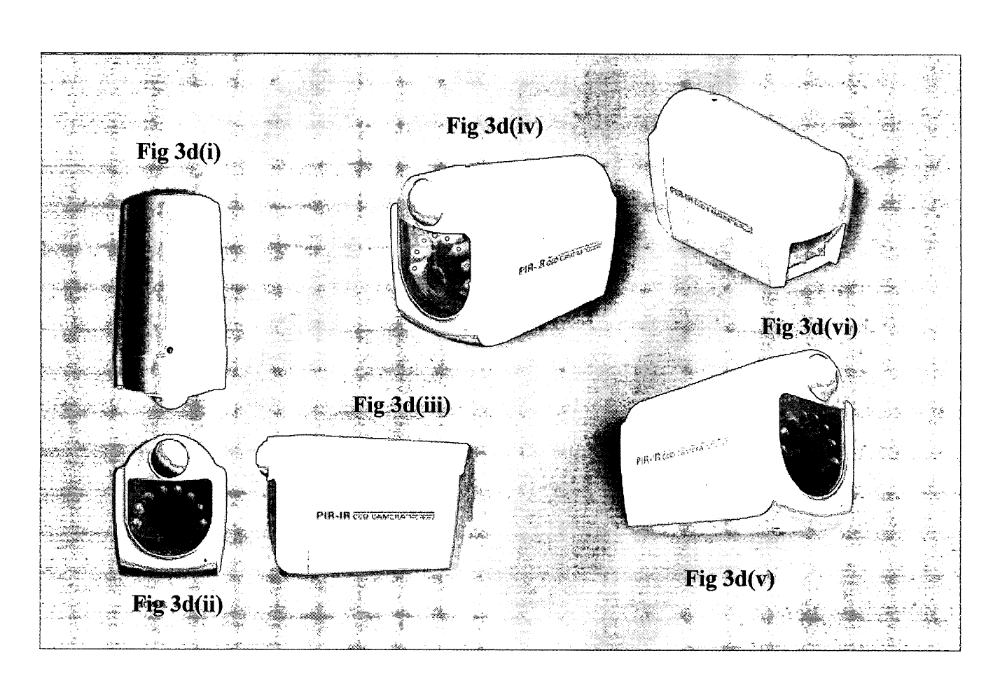

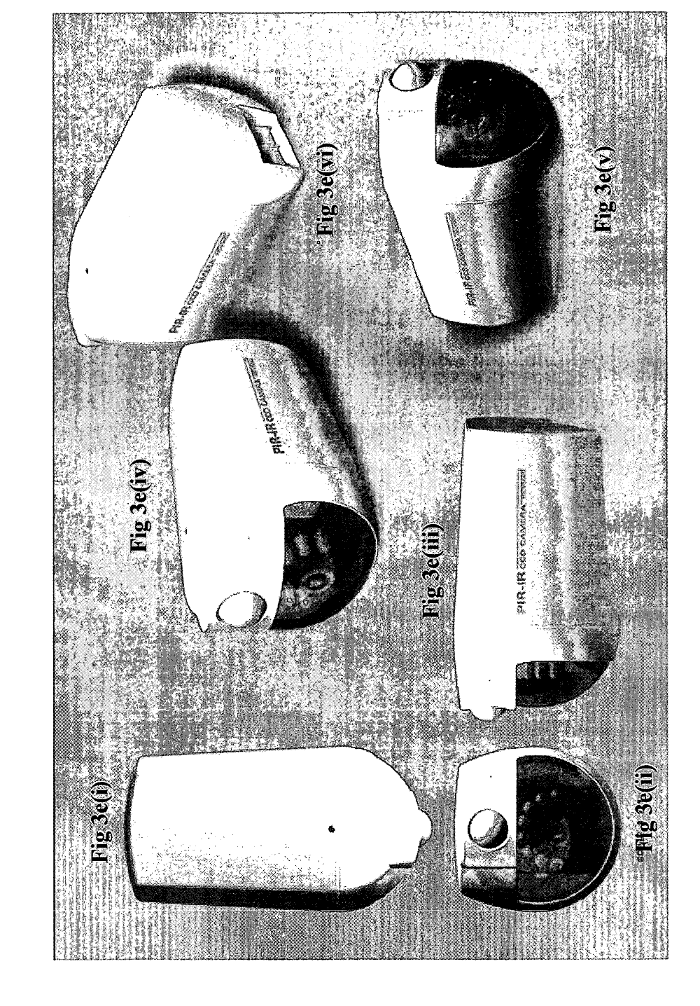

FIGS. 3a-3e illustrate alternate embodiments of the sensor assembly 100 of the present invention, showing each different embodiment from multiple angles. These sensor assemblies 300 are also optionally configured with LED infrared (IR) illuminators 302 of the type well known in the art.

The illustrated embodiment employs well known twisted pair or Category 5 (“CAT 5”) cabling, e.g., 24 AWG multi-conductor cable to transmit the sensor data signals from the sensor assembly 100 to a remote monitoring station 410 (FIG. 4a) which is commonly disposed off-site from the location(s) being monitored. Processed data from the various sensors 100 at the site is transmitted (via the aforementioned cabling 404) to a central distribution board 406 also disposed locally on-site. The distribution board 406 is configured to transmit the signals from each of the various sensor assemblies 100 to the remote monitoring station 410 via any number of communications links including wireless, conventional POTS telephone line, DSL, DOCSIS (cable) modem, dedicated cabling, network (e.g., LAN or the Internet), etc. Such data transmission links are well known in the art and accordingly not described further herein. The distribution board 406 may be configured to packetize the video data (such as using the well known H.323 or other protocols) if desired as well, thereby facilitating packet-switched transmission of the data.

The signal processing board 202 is configured to fit within the housing 104, thereby allowing processing of the video data collected by an individual sensor to be conducted entirely within that sensor assembly 100. Accordingly, signals transferred (whether by twisted pair or Category 5 (CAT-5) cabling, or alternatively via wireless interface) may be viewed directly on a remote monitor without further processing. This approach has the advantage of not generating unprocessed signals (i.e., those with full resolution and clarity subject only to the camera 102), thereby precluding possible surreptitious or accidental viewing of the signals after transmission from the sensor assembly 100 but before processing. Stated differently, there is effectively no possibility of viewing unprocessed sensor data that would compromise the monitored individual's privacy.

However, despite the desirable features associated with the foregoing embodiment, it will be appreciated that signal processing of the sensor data may be conducted remote from the sensor assemblies 100. For example, as shown in FIG. 4b, a central signal processing board 440 is utilized to process unprocessed (raw) video data obtained from each of the sensor assemblies 100. A processor of sufficient MIPS (such as the aforementioned Motorola MSC8102, which utilizes multiple parallel cores for enhanced processing bandwidth) can be used on the central board 440 to facilitate effectively seamless and uninterrupted processing of multiple video data streams in parallel. The video data may also be buffered in, for example, a RAM or FIFO buffer present on the central board 440. FIG. 4c illustrates an embodiment wherein signal processing is conducted at one or more remote processing entities.

This centralized processing approach has as one benefit the simplification (and corresponding cost reduction) of each of the multiple sensor assemblies 100, since each sensor assembly 100 can be made “dumb” in that no internal signal processing is required. Hence, the purchase and replacement cost of each sensor assembly 100 is reduced, thereby ostensibly allowing for additional sensor coverage for the same cost.

The sensor assembly 100 of the present invention may also be fitted with alternate signal transmission capabilities, including wireless (e.g., RF, IR) or home network (e.g., HPN) interface. For example, a wireless signal interface of the type well known in the art can be used for transmission of video data and/or other signals (such as control signals, OOB communications, etc.) from the assembly 100 to a local distribution entity; e.g., the distribution board 406 of FIG. 4a. The video data/signals may transmitted either pre-processing (i.e., as raw video data) or post-processing (i.e., after digital processing to reduce resolution, as previously described). Such interface may comprise, for example a “Bluetooth™” wireless interface, or alternatively, other so-called “3G” (third generation) or “WiFi” communications technologies. The Bluetooth wireless technology allows users to make wireless and instant connections between various communication devices, such as mobile devices and other fixed or mobile devices. Since Bluetooth uses radio frequency transmission, transfer of data is in real-time. The Bluetooth topology supports both point-to-point and point-to-multipoint connections. Multiple ‘slave’ devices (e.g., sensor assemblies 100) can be set to communicate with a ‘master’ device (e.g., distribution board 406). A variety of other configurations are also possible.

Bluetooth-compliant devices, inter alia, operate in the 2.4 GHz ISM band. The ISM band is dedicated to unlicensed user, thereby advantageously allowing for unrestricted spectral access. The wireless interface may use one or more variants of frequency shift keying, such as Gaussian Frequency Shift Keying (GFSK) or Gaussian Minimum Shift keying (GMSK) of the type well known in the art to modulate data onto the carrier(s), although other types of modulation (such as phase modulation or amplitude modulation) may be used.

Spectral access of the device is accomplished via frequency divided multiple access (FDMA), although other types of access such as frequency hopping spread spectrum (FHSS), direct sequence spread spectrum (DSSS, including code division multiple access) using a pseudo-noise spreading code, or even time division multiple access may be used depending on the needs of the user. For example, devices complying with IEEE Std. 802.11 may be substituted in the probe for the Bluetooth transceiver/modulator arrangement previously described if desired. Literally any wireless interface capable of accommodating the bandwidth requirements of the video signal being transmitted may be used, including IRdA or similar. Similarly, the present invention contemplates the transmission of video data to a mobile or handheld device, such as via a wireless application protocol (WAP) compliant device adapted to receive and display such data. This feature is especially useful for an individual desiring to monitor the activity at their residence or business while they are away.

As previously referenced, the present invention may also be configured with one or more motorized mechanisms of the type well known in the art for effecting movement of various components of the assembly 100. For example, motor drives adapted to move the assembly 100 with respect to any spatial dimension may be used. Additionally, motorization of a focus mechanism of the camera (if so equipped) may be employed. In one embodiment, the user controls the camera assembly 100 (or multiple such assemblies) from the remote site.

Method of Manufacturing

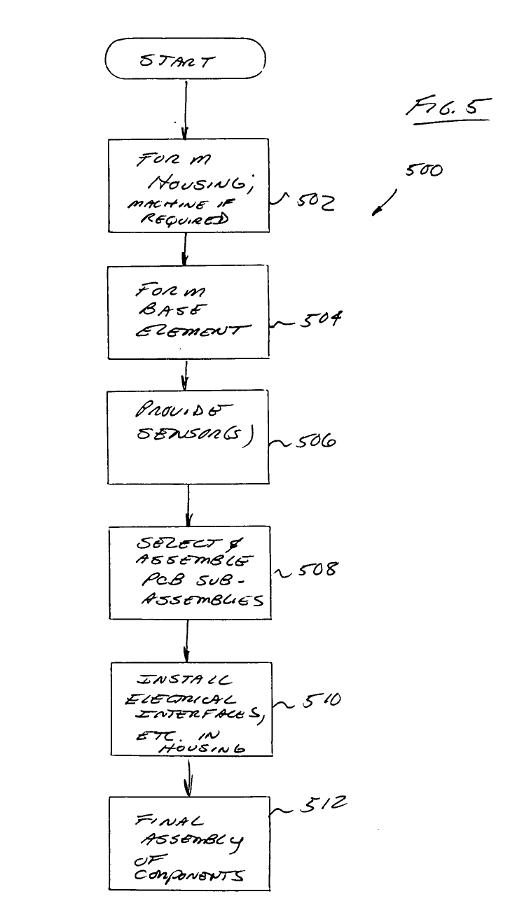

Referring now to FIG. 5, an improved method of manufacturing the apparatus described herein is disclosed. It will be appreciated that while the method 500 is described in terms of the exemplary apparatus of FIGS. 1-2 herein, it may be readily adapted to other configurations of the apparatus, the following being merely illustrative of the broader principles.

As shown in FIG. 5, the method 500 comprises first forming the sensor housing 104 (step 502), particularly the constituent portions 104a, 104b. The housing 104 is formed in the illustrated embodiment using well known and low-cost injection molding techniques, although it will be recognized that other techniques (such as transfer molding, casting, etc.) may be used consistent with the material of choice an the level of detail required, as well as cost considerations. Additionally, the required features associated with the housing, e.g., pinhole aperture 107, etc. are also formed at this time, such as during molding, or alternatively via additional machining or processing steps.

Next, the base element 105 is formed using techniques comparable to those for the sensor housing 104 (step 504). It is noted, however, that since the base element 105 is not required to be replaced (at least at the same frequency as the sensor assembly might be), its cost dynamics and other considerations are somewhat different than those of the housing 104.

Next, per step 506, the sensor element is provided. In the illustrated embodiment, this sensor comprises an ultra-low cost B/W camera, although other types may be substituted.

The signal processing and other internal components of the PCB 202 are then assembled per step 508. These assemblies may be prefabricated if desired before installation. This assembly process includes, inter alia, placement and soldering of the ICs onto the PC board, and any required testing.

The electrical interfaces (e.g., RJ-series jacks), including any required power interface, and associated electrical components are then selected and installed into the housing 104 per step 510 and electrically interfaced with the PCB. Plug-in type electrical connectors are used where possible in order to make the structure as modular as possible, and to facilitate replacement of the PCB 202, when, for example, a component thereon fails.

It will be recognized, however, that the PCB may be disposed external to the housing 104 and interfaced with the sensor (e.g., camera) element within the housing 104 such that the sensor assembly 101 can be replaced at extremely low cost (i.e., without having to replace the PCB.

The housing 104, sensor 102, PCB 202, and base 105 are then assembled into the configuration shown previously with respect to FIGS. 1-2 or 3a-3c (as applicable), using any appropriate hardware (step 512).

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A sensor assembly comprising:
at least one sensor adapted to generate first data; and
at least one processing entity in data communication with said sensor and adapted to process said first data to produce second data, said second data having at least one desired effect associated therewith.

2. The assembly of claim 1, wherein said at least one sensor comprises an optical-band semiconductor camera.

3. The assembly of claim 1, wherein said at least one sensor comprises an IR-band sensor.

4. The assembly of claim 2, wherein said at least one desired effect comprises reduction in the visual clarity of the second data when said second data is displayed by apparatus adapted for viewing of same.

5. The assembly of claim 1, wherein said at least one desired effect comprises selective deletion of portions of the field of view of said at least one sensor when said second data is displayed by apparatus adapted for viewing of same.

6. The assembly of claim 1, wherein said at least one desired effect comprises selective permutation of the order of portions of the field of view of said at least one sensor when said second data is displayed by apparatus adapted for viewing of same.

7. The assembly of claim 4, further comprising a low-cost sensor housing within which at least a portion of said at least one sensor is disposed, wherein said at least one sensor comprises a low cost B/W camera, and said at least one processing entity is disposed external of said housing, such that said sensor assembly is substantially low cost as a whole and hence disposable in nature.

8. The assembly of claim 7, further comprising a base element adapted for mounting said housing thereto, said base element substantially containing said at least one processing entity.

9. The assembly of claim 4, further comprising a low-cost sensor housing within which at least a portion of said at least one sensor is disposed, wherein said at least one sensor comprises a low cost B/W camera, and said at least one processing entity comprises a low-cost integrated circuit disposed within said housing, such that said sensor assembly is substantially low cost as a whole and hence disposable in nature.

10. The assembly of claim 1, wherein said at least one processing entity comprises a digital processor having an embedded memory and a plurality of computer code running thereon, said computer code being adapted to provide said processing of said first data.

11. The assembly of claim 1, wherein said at least one processing entity further comprises an ADC adapted to render said first data in the digital domain.

12. Covert security sensor apparatus, comprising:
at least one camera adapted to generate video signals relating to at least one monitored location;
wherein said apparatus is configured to look like another type of sensor such that the presence of said at least one camera is not readily discernable by inhabitants of said location.

13. The apparatus of claim 12, wherein said another type of sensor comprises a passive IR (PIR) sensor.

14. The apparatus of claim 13, further comprising a passive IR (PIR) sensor.

15. The apparatus of claim 12, further comprising:
at least one processing entity in data communication with said camera and adapted to process said video signals to produce processed video data for viewing; and
at least one distribution entity adapted to distribute said processed data to a remote location.

16. The apparatus of claim 12, further comprising:
at least one processing entity in data communication with said camera and adapted to process said video signals to produce processed video data for viewing, said processed video data comprising an altered representation of said signals.

17. The apparatus of claim 16 wherein said at least one processing entity comprises a digital processor with associated memory, and signal processing algorithm running thereon.

18. The apparatus of claims 17, further comprising a data interface adapted to transfer at least portions of said processed video data to a remote monitoring location.

19. The apparatus of claim 12, wherein said configuring of said apparatus comprises:
providing a housing which appears as that associated with another type of sensor; and
providing a discrete aperture within said housing to accommodate said at least one camera.

20. A security sensor, comprising:
at least one camera adapted to generate video data relating to at least one monitored location;
at least one processing entity in data communication with said camera and adapted to process said video data to produce processed video data for viewing at a remote location; and
at least one distribution entity adapted to distribute said processed data to said remote location;
wherein said processed data allows viewing of only certain features of said monitored location or its inhabitants.

21. Low-cost, replaceable sensor apparatus comprising:
a low cost B/W camera element;
a signal interface operatively coupled to said camera element and adapted for quick connect/disconnect coupling to a complementary external signal interface;
a molded housing element substantially containing said camera element; and
a molded base element removably coupled to said housing element;
wherein said camera element, signal interface, and housing element cooperate to make said sensor apparatus substantially disposable from a cost perspective.

22. The apparatus of claim 21, wherein said camera element is adapted for independent replacement thereof by a user.

23. A quick-change, low-cost sensor assembly adapted to permit removal of a sensor and replacement with another identical or different sensor, comprising:
a sensor element having:
(i) A low-cost molded sensor housing;
(ii) at least one low-cost sensor disposed at least partly within said housing; and
(iii) at least one first electrical interface adapted to transmit electrical power and information signals to and from said at least one sensor; and
a support element adapted to support and removably mate with said sensor element, said support element comprising at least one second electrical interface adapted to transmit electrical power and information signals to and from said at least one first interface;
wherein said at least one first and second electrical interfaces are adapted for rapid separation from each other incident with said removal of said sensor element from said support element.

24. A quick-change, covert sensor assembly, comprising:
a sensor element having:
(i) at least one optical sensor; and
(ii) at least one first electrical interface adapted to transmit electrical power and information signals to and from said at least one sensor; and
a support element adapted to support and removably mate with said sensor element, said support element comprising at least one second electrical interface adapted to transmit electrical power and information signals to and from said at least one first interface;
wherein said at least one first and second electrical interfaces are adapted for rapid separation from each other incident with said removal of said sensor element from said support element; and
wherein said sensor assembly is adapted to appear as a non-visual sensor in order to deceive individuals for which optical monitoring is desired.

25. A method of manufacturing a low-cost sensor assembly, comprising:
providing at least one low cost sensor;
molding a housing member adapted to accommodate at least a portion of said at least one sensor;
disposing said at least one sensor at least partly within said housing member;
providing a quick-disconnect base element adapted for mating with said housing member, said base element facilitating rapid disconnection and replacement of said housing member; and
mating said housing member with said base element.

26. A method of operating a disposable sensor assembly, comprising:
providing a low cost sensor element having a low-cost housing member adapted to accommodate at least a portion of said at least one sensor;
providing a quick-disconnect base element being mated with said housing member, said base element facilitating rapid disconnection and replacement of said sensor element, including electrical signals exchanged there between;
operating said sensor element for a period of time;
disconnecting said sensor element from said base element;
and replacing said sensor element with another.

27. High privacy sensor apparatus, comprising:
at least one sensor adapted to generate first data; and
at least one processing entity in data communication with said sensor and adapted to process said first data to produce second data, said second data intentionally altering said first data sufficiently that video derived therefrom is sufficiently reduced in resolution or content such that details of individuals being monitored by said apparatus are not discernable.

28. The apparatus of claim 27, wherein said details comprise the facial identity of said individuals.

29. The apparatus of claim 27, wherein said apparatus if further adapted to operate in a mode whereby said processing of said first data is substantially altered so as to increase said resolution at least temporarily.

30. A method of operating security monitoring apparatus disposed at a first location, the method comprising:
providing at least one sensor having signal processing apparatus;
processing first data collected by said at least one sensor using said apparatus to produce second data, said second data having at least one attribute associated therewith;
monitoring said first location using said second data; and
selectively, and responsive to a first indication, monitoring said first location using said first data.

31. The method of claim 30, wherein said act of monitoring is conducted at a second location, and said first indication comprises an alarm signal generated substantially at said first location.

32. The method of claim 30, wherein said act of processing to produce second data having at least one attribute comprises processing to reducing the resolution of video generated from said second data sufficiently that the privacy of individuals disposed at said first location is maintained.

33. A remote security monitoring system, comprising:
sensors disposed at one or more locations to be monitored;
at least one processing entity in operative communication with said sensors and adapted to process raw data from the sensors to produce processed data, said processed data having at least one desired attribute not present in said raw data;
at least one remote monitoring entity adapted to utilize the processed data; and
a network interface adapted to transfer said processed data from said processing entity to said remote entity.

34. The system of claim 33, wherein said at least one attribute comprises reduced visual resolution during display.

35. The system of claim 34, further comprising a signal interface;
wherein said system further comprises an operating mode wherein said processing of said raw data to produce said desired attribute is selectively not performed based on data transmitted over said signal interface.
